(19) United States
(12) Patent Application Publication
(10) Pub. No.: US 2009/0001771 A1
(43) Pub. Date: Jan. 1, 2009

(54) MOTOR VEHICLE ROOF

(75) Inventor: Dirk Rainer LUNGERSHAUSEN, Wiesbaden (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/145,091

(22) Filed: Jun. 24, 2008

(30) Foreign Application Priority Data
Jun. 26, 2007 (DE) 102007029582.2

(51) Int. Cl. B60J 7/00

(52) U.S. Cl. 296/210

(57) ABSTRACT

A motor vehicle roof is provided that includes, but is not limited to a base roof and a roof segment. The roof element is adjustable relative to the base roof. The roof segment includes, but is not limited to an upper roof element that is adjustable relative to the roof segment. In addition or alternatively, the base roof includes, but is not limited to a lower roof element that is adjustable relative to the base roof. The upper roof element and/or the lower roof element include, but are not limited to lamellae. As a result, the transportation of objects is improved without significantly compromising safety.

### CROSS-REFERENCE TO RELATED APPLICATION

This application claims priority to German Patent Application No. 102007029582.2, filed Jun. 26, 2007, which is incorporated herein by reference in its entirety.

### TECHNICAL FIELD

The technical field generally relates to a roof for motor vehicles, such as large-capacity passenger vehicles (e.g., vans, station wagons or mini-buses).

### BACKGROUND

From DE 198 31 133 A1, a motor vehicle roof is known to feature a base roof with roof lining. Within the base roof, a roof segment is provided that extends across the entire base roof and which can be swung out of the base roof. When closed, the roof segment aligns itself with the surface of the base roof. When it is opened, the roof segment arranges itself essentially parallel to the starting position, in order to form a small gap between the roof segment and the base roof; this would allow for an equalization of pressure in the interior of the motor vehicle in the event of one or more airbags being released.

The disadvantage of this type of motor vehicle roof is that the movable roof-segment involves a safety-critical building component which must not be hindered in its function. Particularly with large-capacity passenger vehicles such as vans, station wagons, or mini-buses, for example, this presents a disadvantage in that this sort of automobile is often used in order to transport objects; for example, they are used to transport luggage or bulky objects. For the functionality of a large-capacity passenger vehicle, in particular, it is therefore especially important that it be possible to transport objects on the roof. The ability to transport objects on the roof is, however, clearly impaired by a roof segment which is extendable in the case of an emergency; no objects can be transported in the vicinity of this roof segment for reasons of safety.

In view of the foregoing, it is at least one object to create a motor vehicle roof that improves the transportation of objects without significantly compromising safety. In addition, other objects, desirable features, and characteristics will become apparent from the subsequent summary and detailed description, and the appended claims, taken in conjunction with the accompanying drawings and this background.

### SUMMARY

According to an exemplary embodiment of the invention the at least one object, other objects, desirable features and characteristics can be solved a motor vehicle roof including, but not limited to a base roof and an adjustable roof segment relative to the base roof. The roof segment, includes, but is not limited to at least one upper roof element that is adjustable relative to the roof segment and/or the base roof includes, but is not limited to at least one lower roof element that is adjustable relative to the base roof. The upper roof element and/or the lower roof element include, but are not limited to lamellae.

The motor vehicle roof in accordance with an exemplary embodiment of the invention, which is particularly suitable for a large-capacity passenger vehicle (e.g., a van, station wagon, a transporter up to 7.5 tons, or a mini-bus), includes, but is not limited to a base roof through which, in particular, a roof lining for the motor vehicle can be developed. Furthermore, a roof segment is provided, which is adjustable relative to the basic roof and, in particular, is essentially only adjustable in a vertical direction. According to an exemplary embodiment of the invention, the roof segment includes, but is not limited to an upper roof element which is connected to and adjustable relative to the roof segment. In addition or alternatively, the base roof comprises at least one lower roof element which is connected to and adjustable relative to the base roof. The top roof element and/or the bottom roof element include, but are not limited to lamellae in accordance with an exemplary embodiment.

Through the bottom and/or top roof element, any space between the base roof and the roof segment can be opened and closed very easily in order to form an additional storage space, particularly for the reception of baggage. The additional storage space shows that there is additional accessible capacity between the base roof and the roof segment in comparison to when it is closed. This space is preferably sheltered by the roof segment. The storage space is, in particular, dimensioned so that, for example, a suitcase could be stored just in the additional storage space alone. Through the adjustable roof element, the accessibility to the additional storage space which is formed, if required, between the roof lining and the extended roof segment, is made simple. As a result, the motor vehicle roof can also be used, particularly by compact cars, sports-cars or super-sports cars, for which generally no storage space has been designed. Because when the motor vehicle roof is closed it barely accelerates the aerodynamic drag, the maximum speed is hardly affected for vehicles developed for high speeds; additional storage space can be created, where necessary, if the maximum speed is not of higher importance than the available transport volume. In case an upper adjustable roof element is provided, it will be possible to load baggage or other bulky items from the side of the roof. In the case of a lower adjustable roof element, the storage space can be separated from the passenger interior after loading. The design of the roof lining is not compromised as a result. In addition, the lower roof element can be used as a place to deposit objects which have been put in the storage space. With the help of the lower roof element, the passenger interior can not only be enlarged as needed, but it is also possible to create additional space to store objects for transportation. Preferably, the lower roof element aligns itself with the side of the roof lining of the base roof, pointing towards the motor vehicle interior. Through the lamellae provided for the upper and/or lower roof elements, the roof element can be transferred in a particularly compact condition, so that very little storage space is needed for the compacted roof element. Because the roof segment can create such a large gap between itself and the base roof, enabling space for more baggage, it is not necessary to fasten pieces of baggage outside on the surface of the roof segment outside of the motor vehicle roof in order to improve the transportation of baggage. At the same time, at least one adjustable roof element can be configured to open, so that, in the event of the airbags being activated, an equalization of pressure is possible across the roof element, thus ensuring that safety is not compromised. For this purpose, the adjustment of only one single lamella is sufficient. The adjustment of the entire roof segment is not required in order to make an equalization of pressure possible. In particular, in the case of long and/or bulky objects, it is possible to clamp these between the roof segment and the base roof, so that additional security for the cargo is ensured.

Preferably the lamellae can be arranged one beneath the other and/or one above the other and/or can be interspersed. The roof element can be transformed in this way from a long, flat state into a compact state. In a long, flat state, the lamellae of the roof element can close the storage space. In a compacted state, the storage space is opened. In this manner, the roof element is not in the way during the loading of baggage into the storage space. Depending on the case of application, the lamellae can, in particular, perform a rotation (for example: at about 90°±10°), so that the lamellae whose fronts point towards each other in a closed state point above and below in an opened state. The discs are arranged one behind the other in this case and the sides with the biggest surfaces in a compact, open state also point towards each other.

In a particularly preferred embodiment, the motor vehicle roof comprises a spoiler, which is connected with the base roof in an adjustable or non-adjustable way. In this case, the lamellae of the roof element can be arranged in a compacted state underneath the spoilers, so that, in essence, the lamellae can be arranged in a compacted state in the area between the spoiler and the base roof. The compacted lamellae are, in this case, arranged in a space within the storage space which is usually not needed for loading and unloading the storage space.

In a preferred embodiment, the upper roof element and/or the lower roof element are, at least partially, developed transparently. In particular, it is preferred for one roof element to be, in essence, transparent and the other to be opaque. That is, either the upper roof element is at least partially transparent and the lower roof element is opaque, or the lower roof element is at least partially transparent and the upper roof element is opaque. Because of the transparency of at least one of the roof elements, a window is formed in the roof element in order to improve the brightness in the motor vehicle interior when additional storage space is not needed. In particular, when one roof element is transparent and the other is opaque, each opaque roof element can be additionally used as protection from the sun. For example, the upper roof element can be transparent in order to let sunlight into the motor vehicle interior. If required, the lower roof element can be brought into a closed state, thus providing protection from the sun; alternatively, it can be brought into an opened state in order to let the sunlight into the motor vehicle interior. In particular, when, in this case, the lower roof element shows many lamellae, the sun-protection function is particularly easy to put into effect.

In a preferred embodiment, a loading sensor pointing to the storage space is provided between the roof lining of the base roof and the roof segment, for the detection of objects. The loading sensor detects whether or not there is an object in the storage space formed in between the roof segment and the base roof, so that at least a warning signal can be released in case the lower roof element needs to be adjusted. An unintentional falling out of objects from the storage space into the motor vehicle interior can thereby be avoided. In particular, the loading sensor is connected to an operation unit and/or an activation device for the operation unit, so that opening the lower roof element is only possible when the loading sensor does not detect any cargo. In the event that cargo is detected, the loading sensor can activate a locking-mechanism which prevents the opening of the lower roof segment. The loading sensor can be developed as passive or active, wherein an active sensor is preferably only briefly activated when the lower roof element is supposed to be activated; an electrical signal is sent out for this purpose, which starts the loading sensor before the lower roof element is opened in response to the signal received from the loading sensor. The loading sensor can, for example, as a strain gage, detect the weight of an object placed on the lower roof element. The volume of something located in the storage space can further be detected through the aid of an ultrasound and/or laser and/ or a light barrier.

Preferably, the roof segment fits tightly with the base roof when it is in a closed state. In an opened state, that is, when there is a gap between the roof segment and the base roof, the additional storage space will be used to store baggage pieces. The storage space is, in particular, dimensioned in such a way that a suitcase, for example, can be stored in just the additional space.

Preferably, at least one locking device is provided in order to be able to lock the roof element and/or the roof segment and/or individual lamellae, particularly in different positions. For this purpose, a stopping mechanism can be provided, or a brake, which can lock the roof element and/or the roof segment and/or the lamella smoothly. It is particularly preferred that the locking device can be activated by remote control. As a result, it is, for example, possible to lock or unlock the roof element and/or the roof segment and/or at least one lamella through the remote control signal of a motor vehicle key. Additionally, or alternatively, the roof element and/or the roof segment and/or the lamella can, for example, be activated electrically from the motor vehicle interior. For this purpose, a corresponding switch is provided on the driving panel.

In a preferred embodiment, the roof segment is flexibly bound with a spoiler. The spoiler is, in particular, bound flexibly and/or in a horizontally shiftable way with the base roof. If the roof segment is moved out of the level of the base roof, the spoiler is moved along with it or the other way around, so that the roof segment, in an opened, lowered state, does not substantially accelerate the aerodynamic drag of the motor vehicle. In order to equalize, if necessary, a changing clearance between the spoiler and roof segment, a length adjustment can be provided between the roof segment and the spoiler. The length adjustment is achieved, for example, by a flexible, particularly elastic material that can simultaneously repel rain water. In order to guarantee a k connection between the spoiler and the roof segment, the spoiler and the roof segment can be connected by a lengthwise shiftable slide control.

In order to protect the storage space from environmental influences, a flexible protective cover can be connected with the roof segment and with the base roof. The protective cover can, for example, be developed in such a way that, when the roof segment is in a retracted state, it is folded up, and when the roof segment is in an extended state, it forms endwalls for the storage space. Furthermore, the protective cover can comprise opening devices in order to open the protective cover within a subarea. For example, the protective cover comprises a zipper in order to open the portion of the protective cover which goes against the direction of travel, so that especially long objects, such as surf boards, can be transported without additional problems.

It is particularly preferred that the roof segment comprise, in a maximally opened state, a vertical clearance to the base roof of ≧about 10 cm, in particular ≧about 30 cm, preferably ≧about 50 cm, particularly preferred ≧about 80 cm. Through this dimensioning of the clearance between the roof segment and the base roof, the clearance is always measured from the surface of the roof segment to the surface of the base roof, a volume for the storage space that is large enough to store objects, particularly pieces of luggage or bulky objects, is achieved.

In order that objects can also be bound to the motor vehicle roof next to the adjustable roof segment without the adjustable roof segment being able to bump into the already fastened objects, it is preferred to keep a horizontally directioned offset of the roof segment as minimal as possible. For this purpose, the roof segment can, in its maximally opened state, and in comparison with its closed state, comprise a horizontally directioned offset of ≦about 10 cm, particularly ≦about 5 cm, preferably ≦about 2 cm, and particularly preferably ≦about 1 cm and further preferably ≦0.5 cm. Through this dimensioning of the offset, the function of the motor vehicle roof as a transport mechanism for more objects on the motor vehicle roof is not further compromised; simultaneously, many alternative activation devices for the adjustment of the roof segment can be chosen according to each case of application.

The exemplary embodiments of the invention further apply to a motor vehicle body, which is particularly designated for vans, station wagons, or mini-buses and comprises a motor vehicle roof, which can be developed and improved as described above. Preferably, a left roof pillar and a right roof pillar are provided, so that the motor vehicle roof can be safely connected with the motor vehicle body as one single module. The motor vehicle roof can, in particular, be locked to the roof pillars, so that the roof pillars can bound the base roof. Particularly, a right railing and a left railing are provided in order to aid the fastening of luggage pieces and bulky objects to the motor vehicle roof. Preferably, the roof segment, in its maximally opened state, comprises a gap between itself and the surface of the base roof which is bigger than the about 1.5-fold, in particular the about 2-fold, preferably the about 3.5-fold and particularly preferably the about 5.0-fold of the clearance between the surface of the roof railing and the surface of the base roof. As a result of this dimensioning of the clearance between the roof segment and the base roof, an additional fastening device can be formed with the aid of the roof segment, through which an object which is to be transported can be fastened to the motor vehicle roof and, in particular, can be tied to it. For example, the object which is bound to the roof railing can be protected from the airstream during driving by the extended roof segment. It is particularly preferred that the surface of the roof segment is located at essentially the same level as the surface of the roof railing, so that the aerodynamic drag against the direction of travel is not substantially accelerated and, at the same time, that a depression in the roof lining and/or the base roof for the inclusion of the roof segment is not necessary.

Preferably, the roof segment extends from the left roof pillar to the right roof pillar, and the storage space can be enlarged as needed over the entire width of the motor vehicle roof.

### BRIEF DESCRIPTION OF THE DRAWINGS

The present invention will hereinafter be described in conjunction with the following drawing figures, wherein like numerals denote like elements, and

FIG. 1 shows a perspective view of a motor vehicle with the motor vehicle roof in accordance with the invention in accordance with a first exemplary embodiment;

FIG. 2 shows a perspective inner view of the motor vehicle from FIG. 1; and

FIG. 3 shows a side view of the motor vehicle roof from FIG. 1.

### DETAILED DESCRIPTION

The following detailed description is merely exemplary in nature and is not intended to limit the application and uses. Furthermore, there is no intention to be bound by any theory presented in the preceding background and summary or the following detailed description.

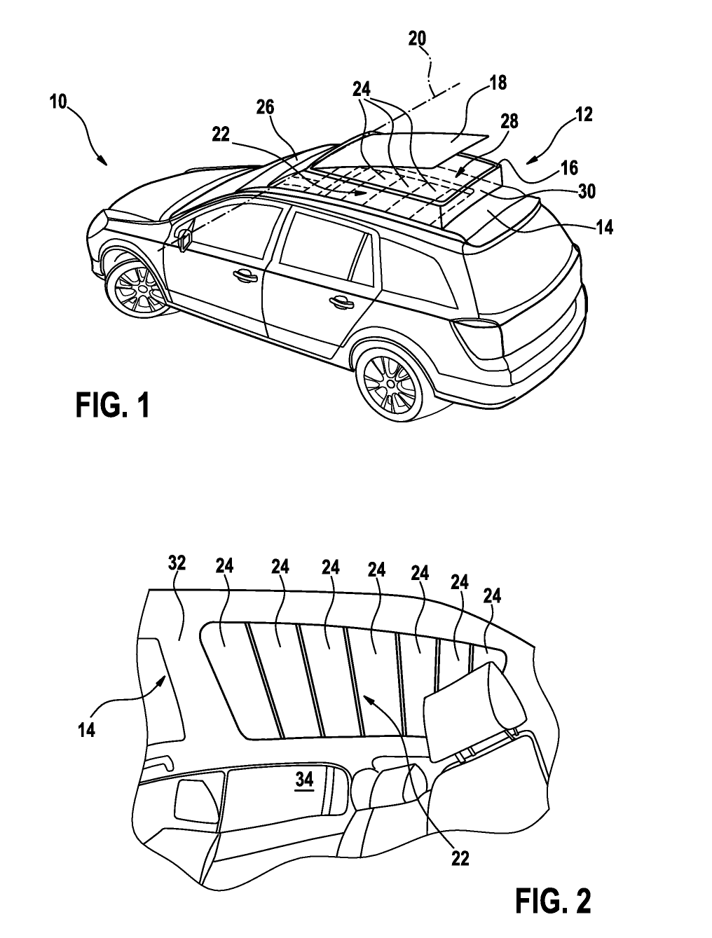

A motor vehicle 10, such as presented in FIG. 1, comprises a motor vehicle roof 12, which comprises a base roof 14 and a roof segment 16, which is essentially adjustable in a vertical direction. In the example embodiment, the roof segment 16 comprises an upper roof element 18, which is hinged on the face around a pivot axle 20, which is arranged laterally to the direction of travel. Alternatively, the upper roof element can comprise numerous parts, which can be compacted in the same way as lamellae, for example: on top of each other, one behind the other, underneath each other or interspersed with each other.

In the example embodiment, the base roof 14 comprises a lower roof element 22 which comprises numerous lamellae which, in the direction of travel and/or against the direction of travel, can be compacted on top of each other or underneath each other or interspersed with each other. In order to reduce the aerodynamic drag when the roof segment 16 is extended, the roof segment 16 is connected to a spoiler 26, which when the spoiler 26 moves, the roof segment 16 automatically moves along with it. The upper roof element 16 and/or the lower roof element 22 as well as the spoiler 26 can be developed as at least partially transparent in order to make possible the lighting of the motor vehicle interior 34 through sunlight. In the presented embodiment example, the upper roof element 16 is comparable to a window in its transparent design, while the lamella 24 of the lower roof element are made opaque in order to provide protection from the sun, if needed.

The gap between the roof segment 16 and the base roof 14 is in an opened, that is, an extended state, and is dimensioned in such a way that a storage space 28 is developed with a volume large enough to encompass luggage and/or bulky objects. The storage space 28 comprises, in particular, a volume of at least 100 liters, preferably 200 liters and particularly preferably 300 Liters or greater. In particular, it is possible in the presented implementation examples to use the transport volume of the motor vehicle interior 34 as well as the transport volume of the storage space 28 for the transportation of objects because the object in the motor vehicle interior 34 can intrude on the storage space 28 when the lower roof element 22 is open.

Between the roof segment 16 and the base roof 14, a protective cover 30 can be provided in order to protect the storage space 28 from environmental influences. The protective cover 30 is particularly designed in such a way that when the roof segment 16 is retracted, the protective cover 30 automatically folds together.

When the lower roof element 22 is in a closed state, the lamellae 24 essentially align themselves to a roof lining 32, which is formed through the lower side of the base roof 14 (see FIG. 2). Through the lamellae 24 of the lower roof element 22, a motor vehicle interior is separated from the storage space 28, so that no objects from the storage space 28 can fall into the motor vehicle interior 34. Furthermore, a stable loading surface is formed for the storage space 28.

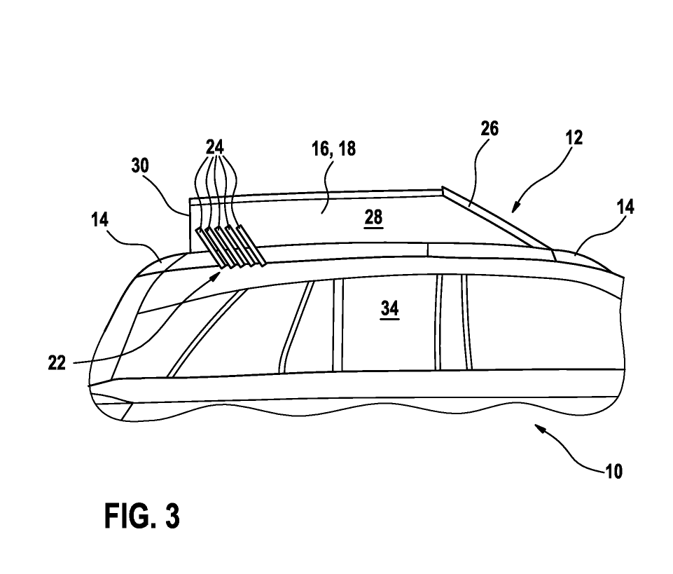

When the lower roof element 22 is in an opened state (see FIG. 3), the lamellae 24 are always ordered one behind the other and are located in a compact state in which they demand very little of the storage space 28. Furthermore, in this state, the volume of the motor vehicle interior 34 is connected with the volume of the storage space 28 for the purpose of transporting particularly large objects.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle roof, comprising:
a base roof; and
an adjustable roof segment relative to the base roof,
wherein the adjustable roof segment comprises at least an upper roof element that is adjustable relative to the adjustable roof segment
wherein the base roof comprises at least a lower roof element that is adjustable relative to the base roof, and
wherein at least one of the upper roof element and the lower roof element comprise lamellae.

2. The motor vehicle roof according to claim 1, wherein the lamellae is compactable.

3. The motor vehicle roof according to claim 1, wherein a spoiler is connected to the base roof and the lamellae is arranged in a compacted state underneath the spoiler.

4. The motor vehicle roof according to claim 1, wherein at least one of the upper roof element and the lower roof element is at least partially transparent.

5. The motor vehicle roof according claim 1, wherein the upper roof element is at least partially transparent and the lower roof element is opaque.

6. The motor vehicle roof according to claim 1, wherein the adjustable roof segment in a closed state fits closely with the base roof and in an opened state provides an additional storage space formed between the base roof and the adjustable roof segment.

7. The motor vehicle roof according to claim 6, further comprising a loading sensor for a detection of objects in the additional storage space.

8. The motor vehicle roof according to claim 6, further comprising a flexible protective cover for protection of the additional storage space that is connected with the adjustable roof segment and the base roof.

9. The motor vehicle roof according to claim 1, further comprising a locking device configured to latch at least one of the adjustable roof segment, the upper roof element, the lower roof element, and the lamellae.

10. The motor vehicle roof according to claim 1, wherein the adjustable roof segment opened to a maximum capacity comprises a vertical space of at least about 10 cm between it and the base roof.

11. The motor vehicle roof according to claim 1, wherein the adjustable roof segment opened to a maximum capacity in comparison with its closed state has an offset in a horizontal direction of less than about ≦10 cm.

12. The motor vehicle roof according to claim 1, further comprising a right railing and one left railing and the adjustable roof segment in a maximally opened state forms a gap between itself and the base roof that is greater than the about 1.5-fold of the gap between a surface of the right railing, left railing and a surface of the base roof.

13. The motor vehicle roof according to claim 12, further comprising a left roof pillar and a right roof pillar and the base roof is connected with the left roof pillar and the right roof pillar.

14. The motor vehicle roof according to claim 12, wherein the adjustable roof segment extends from the left roof pillar to the right roof pillar.
